(19) United States
(12) Patent Application Publication
(10) Pub. No.: US 2013/0347039 A1
(43) Pub. Date: Dec. 26, 2013

(54) GRAPHICAL USER INTERFACE FOR MEDIA CONTENT SELECTION

(71) Applicants: Walter R. Klappert, Malvern, PA (US); William L. Thomas, Crystal Lake, IL (US); Tyson Wintibaugh, Calabasas, CA (US)

(72) Inventors: Walter R. Klappert, Malvern, PA (US); William L. Thomas, Crystal Lake, IL (US); Tyson Wintibaugh, Calabasas, CA (US)

(73) Assignee: UNITED VIDEO PROPERTIES, INC., Santa Clara, CA (US)

(21) Appl. No.: 13/529,055

(22) Filed: Jun. 21, 2012

(51) Int. Cl. H04N 21/482

(52) U.S. Cl. 725/46

(57) ABSTRACT

Methods and systems are described herein for providing improved selection of media content through the use of a graphical user interface. The graphical user interface may allow a user to quickly and easily balance multiple interests and make an appropriate selection from available content through the use of movable objects within a polygonal perimeter.

### BACKGROUND OF THE INVENTION

The amount of media content currently available to any one person can be substantial. In addition to different television channels, media content may be available through subscription or Video-On-Demand (“VOD”) services or across different platforms such as Internet based sources. Therefore, it may be difficult for a person to know what media content is available to them. Moreover, even if a person is aware of available media content, a person may not know whether or not the particular media content appeals to their interests.

Furthermore, in many situations, a person may watch media content with other people. Each person may have individual interests, which further complicates the selection process for determining what media content to watch. Even if each person is aware of their particular interest and the media content that appeals to their interest, it may still be overwhelming to balance the interests of all users in the group.

Given the plethora of program options available to a user, it may be difficult for the user to correctly select a program based on the user's specific interests. In many instances, a user may wish to receive a recommendation for a program, which is likely to be of interest to the user. Furthermore, a user may also wish to consider the interests of others in the recommendation. For example, the person may decide to watch a program with a group of people. This further complicates the selection process, as the user may not know what criteria to use to select a program and may not fully understand the interest of others or the content of all available programs.

### SUMMARY OF THE DISCLOSURE

Accordingly, methods and systems are described herein for providing improved selection of media content through the use of a graphical user interface. The graphical user interface may allow a user to quickly and easily balance multiple interests and make an appropriate selection from available media content without knowing what the multiple interests are or what media content is included in those interests.

The on-screen interface may graphically represent the interests, or groups of interests, of particular people. By using content selection criteria particular to individual people's interests, the on-screen interface may present a recommendation such as a program or list of programs to the users that best accounts for each person's individual interests. The users may further wish to adjust the program selection used by the on-screen interface to prefer the interests of a particular user or users.

For example, a family may wish to watch a program together and want the program to appeal more to the interests of the children. Therefore, by adjusting the weight given to individual users' interests, the on-screen interface may present a media content selection (e.g., a particular program or list of programs) recommendation to the users.

In order to easily adjust the content selection criteria, without requiring an understanding of the underlying functions of the selection process, the on-screen interface appears as a graphical user interface, featuring moveable objects. For example, the on-screen interface may have any polygonal shape, where the corners of the polygon are each an equal distance from the center point, or nexus, of the polygon. Each corner, or end point, may be connected to the center point by a line segment. In addition, an adjustable indicator may be configured to move along the line segment between the center point and the end point.

The corner, or end point, may represent a particular user's interests or profile containing the user's particular content selection criteria. The end point may be represented by a name or illustration to help identify the particular user. Sliding the indicator closer to the end point may affect the underlying media content selection such that the interests of that user or profile are more heavily considered during the selection process.

Advantageously, the on-screen interface is so intuitively designed that it may be used, even by children, with little to no instruction. Furthermore, users of the graphical user interface are not required to have any understanding of the underlying function of the content selection process or selection criteria involved in the resulting media selection.

In some embodiments, a media content selection may be displayed by a graphical user interface. The graphical user interface may have multiple profiles, each of which may have media content selection criteria. The profiles may be linked to line segments rendered in the graphical user interface. The line segments may be rendered to originate from a common nexus. Each line segment may also end at a respective point and have an indicator that may be moved along the length of its respective line segment.

By adjusting the position of the indicator on one line segment, a weight for the media content selection criteria of the profile linked to the line segment is determined based on the distance on the line segment between the indicator and the nexus. A media content selection may then be generated partly based on the weighted media content selection criteria of the multiple profiles.

In some embodiments, adjusting the indicator on one line causes the indicators in the remaining lines to be adjusted. In some embodiments, a numerical value indicates the weight given to the media content selection criteria of each profile. In some embodiments, the graphical user interface includes an inner boundary. The inner boundary may have a sum value, which is calculated based on the sum of the numerical values indicating the weight of each profile. The inner boundary may maintain the sum value while the position of one indicator on one line segment is adjusted by adjusting the position of the indicators on the remaining line segments.

In some embodiments, the line segments of the graphical user interface may also be ordered about the nexus based on the profiles. In addition, in some embodiments the line segments may all have an equal length and spacing. In some embodiments, a list may be rendered displaying multiple media content selections. In some embodiments, the media content selections in the list may be ranked according to a composite selection metric.

In some embodiments, the media content selection may be partly based on additional restrictions not associated with the media content selection criteria of any profile. In some embodiments, the profiles used to determine the media content selection criteria may be altered by adding or removing line segments linked to the particular profile from the graphical user interface.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media listing display that may be used to select available media content in accordance with some embodiments of the disclosure;

FIG. 2 shows an illustrative media listing display that may be used to select available media content in accordance with some embodiments of the disclosure and further including a graphical user interface;

FIG. 3 is a block diagram of an illustrative user equipment device in accordance with some embodiments of the disclosure;

FIG. 4 is a block diagram of an illustrative media system in accordance with some embodiments of the disclosure;

FIG. 5A is a graphical user interface in accordance with some embodiments of the disclosure;

FIG. 5B is a graphical user interface in accordance with some embodiments of the disclosure further showing the movement of indicators;

FIG. 5C is a graphical user interface in accordance with some embodiments of the disclosure further including numerical displays and a media content selection list;

FIG. 6A is a graphical user interface in accordance with some embodiments of the disclosure including four profiles;

FIG. 6B is a graphical user interface in accordance with some embodiments of the disclosure including four profiles and further adjusting the graphical user interface to increase the weight associated with one profile;

FIG. 6C is a graphical user interface in accordance with some embodiments of the disclosure including four profiles and further adjusting the graphical user interface to increase the weight associated with one profile;

FIG. 6D is a graphical user interface in accordance with some embodiments of the disclosure including four profiles and further adjusting the graphical user interface to increase the weight associated with two profiles;

FIG. 7A is a graphical user interface in accordance with some embodiments of the disclosure including three profiles;

FIG. 7B is a graphical user interface in accordance with some embodiments of the disclosure including three profiles and further adjusting the graphical user interface to increase the weight associated with one profile;

FIG. 7C is a graphical user interface in accordance with some embodiments of the disclosure including three profiles and further adjusting the graphical user interface to increase the weight associated with one profile;

FIG. 7D is a graphical user interface in accordance with some embodiments of the disclosure including three profiles and further adjusting the graphical user interface to increase the weight associated with one profile;

FIG. 8A is a graphical user interface in accordance with some embodiments of the disclosure including four profiles;

FIG. 8B is a graphical user interface in accordance with some embodiments of the disclosure showing the result of a user removing a profile from the graphical user interface;

FIG. 8C is a graphical user interface in accordance with some embodiments of the disclosure showing the result of a user adding profiles to the graphical user interface;

FIG. 9 is a flow-chart of illustrative steps involved in providing a graphical user interface to select media content in accordance with some embodiments of the disclosure;

FIG. 10 is a flow-chart of illustrative steps involved in making a media content selection based on media content selection criteria in a user profile;

FIG. 11 is a flow-chart of illustrative steps involved in a graphical user interface to select media content in accordance with some embodiments of the disclosure and further illustrating steps involved in determining the number of profiles, shape of the graphical user interface, and the order of the profiles about the nexus in the graphical user interface;

FIG. 12 is a flow-chart of illustrative steps involved in making a media content selection based on media content selection criteria in a plurality of user profiles;

FIG. 13 is a flowchart of an illustrative process used to determine a composite selection metric value associated with particular media content in some embodiments of the disclosure; and

FIG. 14 shows an exemplary data structure for a user profile in accordance with some embodiments of the disclosure.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application, a guidance application, an on-screen interface or a graphical user interface.

The graphical user interface may assist a user by producing a media content selection. As used herein, a media content selection is content, or a list of content, provided as a recommendation to a user based on the underlying function of the graphical user interface.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset,” “media content,” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users.

As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

Some of the embodiments within this disclosure may refer to, discuss using, or basing media content selections on a profile. A profile is a collection of media content selection criteria, which may be data on various topics such as demographics, viewing history, or information, of interest to the user, related to media content based on a user, group of users, interests, or group of interests. Throughout this disclosure any of these traits or a combination of these traits and other information may be used in any embodiment when developing a profile.

For example, a user profile may contain information relating to, age, gender, income level, race and ethnicity. In addition, a user profile may contain information relating to, particular programs that were watched, not watched, advertised but not watched, watched but not advertised, related to watched programs, not related to watched programs, watched in a series, not watched in a series, watched individually, not watched individually, watched with particular other programs, not watched with particular other programs, or any other feasible method or combination of multiple methods.

A user profile may also contain information relating to any media content or any action relating to media content, such as those listed in the preceding paragraph. For example, a profile may include industry information (e.g., ratings, content warnings, advisory warnings), provider information (e.g., upcoming programs, new releases, spin-offs), third party information (e.g., reviews, opinions, fan-generated content) or any other measurement or information that may affect a viewer's choice in programming. Furthermore, the information in a profile may be of a single person, user or group, or multiple people, users or groups. In addition, the profile may relate to specific interests of a particular user. The profiles may also be different categories, genres, or types of programming (e.g., a reality-based show, a comedy, or sports broadcast).

The profile will use the data within it to generate media content selection criteria. Media content selection criteria, as used herein, refers to the inputs used to determine a media content selection. Media content selection criteria may be data associated with a user, group of users, interests, or group of interests, in relation to media content, which may include preferences, actions or decisions related to the performance, distribution, recommendation, creation or consumption (including purchasing) of media content. For example, media content selection criteria for a particular user may include data about the particular genre of movies the user enjoys. In another example, media content selection criteria may include data regarding the user's favorite actor(s). In another example, media content selection criteria may include critical reviews by a particular critic favored by the user.

In some embodiments, a profile may compile data about a user. Based on this data the profile will generate recommendations for the individual user. As the system may have multiple users, the system may weight each of recommendations provided by each individual user. After weighting the individual recommendations, the graphical user interface may generate a media content selection. In some embodiments, the profile data in the user profile may be used as media content selection criteria. The graphical user interface may weigh the media content selection criteria of the individual profiles. Based on this weight the graphical user interface will compute a media content selection for the user. In some embodiments, the graphical user interface may also include profiles located remotely or on third party systems. For example, in some embodiments, profiles from a social media network may be accessed by the graphical user interface.

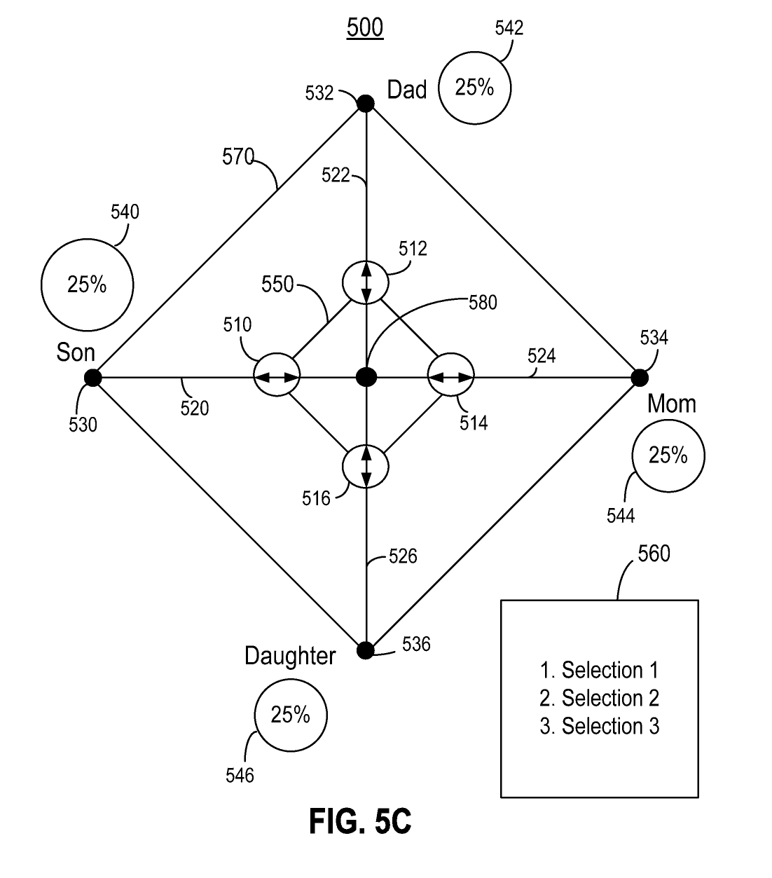

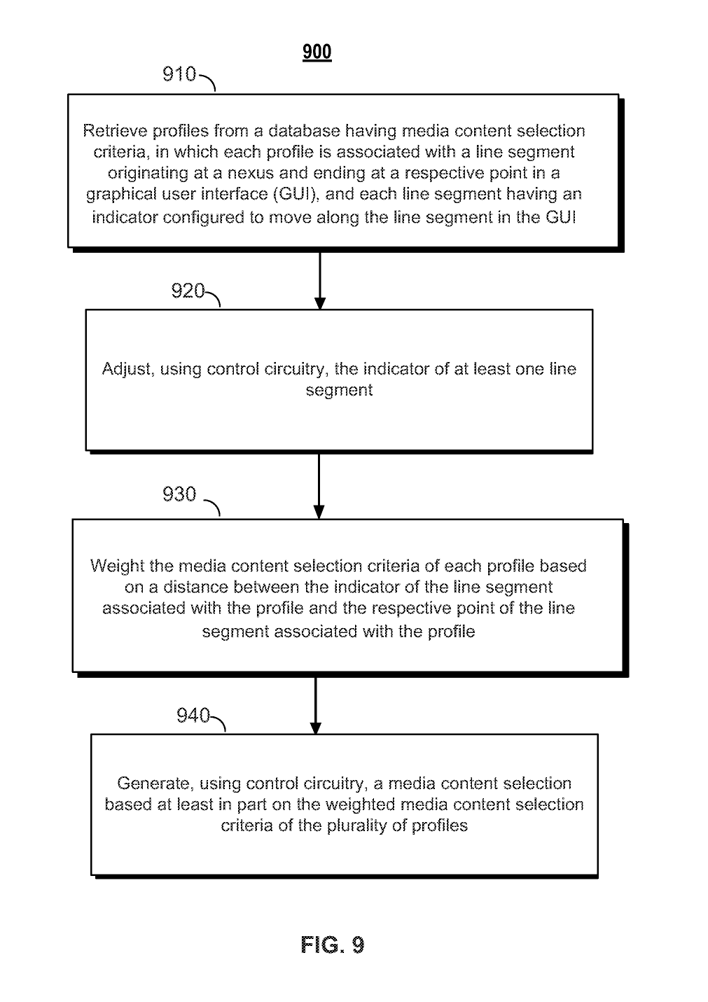

It should also be noted that embodiments of the present disclosure (e.g., process 900 (FIG. 9)) may also be applied to other areas not related to media content (e.g., parental controls). In such embodiments, the end points (e.g., end points 530, 532, 534, and 536 (FIG. 5A)) of the graphical user interface (e.g., graphical user interface 500 (FIG. 5A)) may not be associated with profiles. Instead, the end points may represent categories from which a user may wish to receive recommendations after weighting the categories. For example, each end point (e.g., end points 530, 532, 534, and 536 (FIG. 5A)) may correspond to a different category of media (e.g., film, television, internet, etc.). A parent may wish to set the level of parental controls for each category by moving an indicator (e.g., indicators 510, 512, 514, and 516 (FIG. 5A)) associated with each category along each category's line segment (e.g., line segment 520, 522, 524, and 526 (FIG. 5A)). The graphical user interface (e.g., graphical user interface 500 (FIG. 5A)) may then set the level of parental controls for each category based on the position of the indicators.

It should also be noted that some embodiments of this disclosure (e.g., process 900 (FIG. 9)) may be applied to non-media content interest profiles (e.g., collections of information not relating to media content interests which may or may not be related to a user). In such systems, the graphical user interface may be applied to, or used in conjunction with, other systems or methods, which provide recommendations or selections based on the weighting of certain criteria. For example, each end point (e.g., end points 530, 532, 534, and 536 (FIG. 5A)) may represent a different category of food (e.g., meats, fruits, dairy, vegetables). A user may wish to set the level of each food group in their diet by moving an indicator (e.g., indicators 510, 512, 514, and 516 (FIG. 5A)) associated with each category along each category's line segment (e.g., line segment 520, 522, 524, and 526 (FIG. 5A)). The graphical user interface (e.g., graphical user interface 500 (FIG. 5A)) may then select meals based on the position of the indicators.

The on-screen interface may graphically represent the interests, or groups of interests, of particular people using a variety of objects. The on-screen interface may include a nexus. A nexus as used herein refers to the point of the on-screen graphic, from which a plurality of line segments originates. In some embodiments, the nexus will also be the center point of a polygon. The center point of the polygon means that the nexus is equal distance from every corner of a polygon. In some embodiments, the nexus may be the center point of a circle, meaning the point is equal distance to every point lying on the circumference of the circle.

The on-screen interface may include a plurality of line segments. As used herein, the plurality of line segments refers to the line segments, whether curved or straight, originating from the nexus and ending at an end point. In some embodiments, each line segment is associated with one or more profiles. In some embodiments, each line segment is of equal length. In some embodiments, the on-screen interface may have a plurality of line segments. Each line segments may be associated with a different profile, or group of profiles.

The end point as used herein, refers to the point on the line segment, whether or not it is demarcated as such, which is the furthest point away from the nexus that an indicator, without other constraints, can be moved. For example, in some embodiments, the movement of an indicator may be affected based on the placement of other indicators on other line segments. In this case, the end point would refer to the furthest point away from the nexus that the indicator could be moved without being constrained by the placement of the other indicators.

The on-screen interface may include an indicator. As used herein, an indicator refers to an object movable about the length of a line segment upon which it sits. In some embodiments, the indicator is associated with a single line segment. In some embodiments, an indicator may be associated with one or more profiles. In some embodiments, the on-screen interface may have a plurality of indicators. Each indicator may be associated with a different profile, or group of profiles.

In some embodiments, the on-screen interface may include a perimeter. As used herein, the perimeter refers to a shape formed through the connection of adjacent end points about the nexus. For example, if the on-screen interface includes three line segments, the perimeter may be in the shape of a triangle, wherein the nexus is the center point of the triangle.

In some embodiments, the on-screen interface may include an inner boundary. An inner boundary as used herein refers to the shape made through the connection of adjacent indicators about the nexus. For example, if the on-screen interface includes three line segments, the inner boundary may appear as a triangle (equilateral, isosceles or scalene) within the triangular perimeter of the on-screen display.

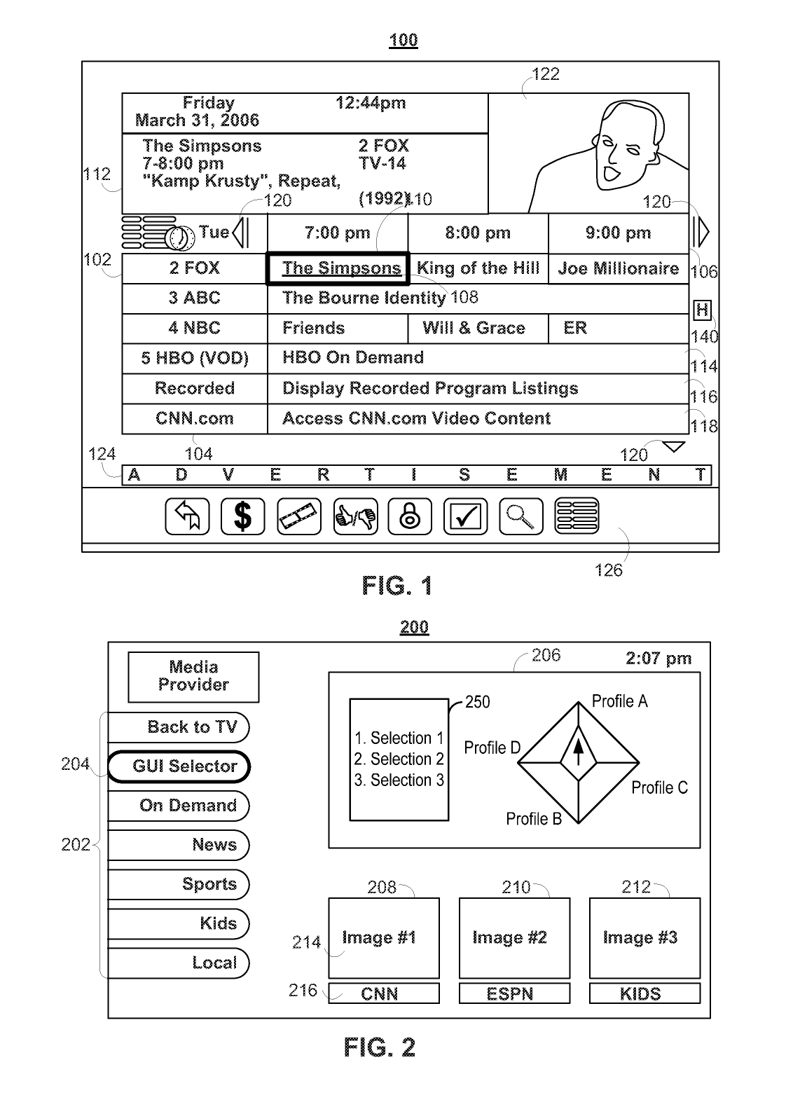

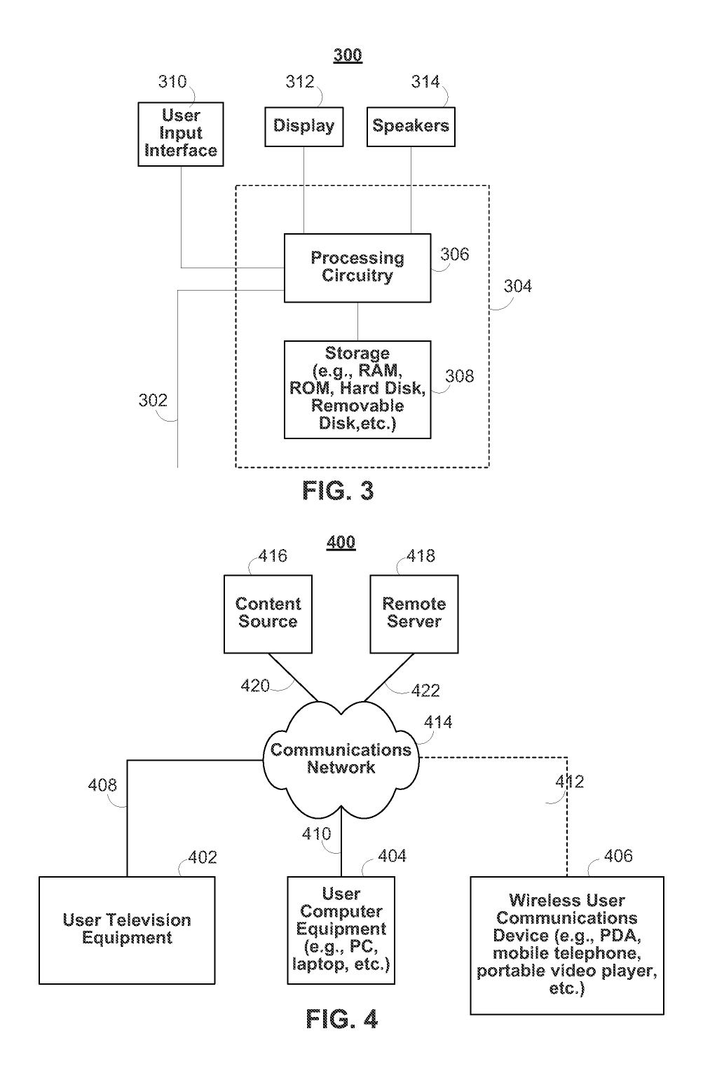

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

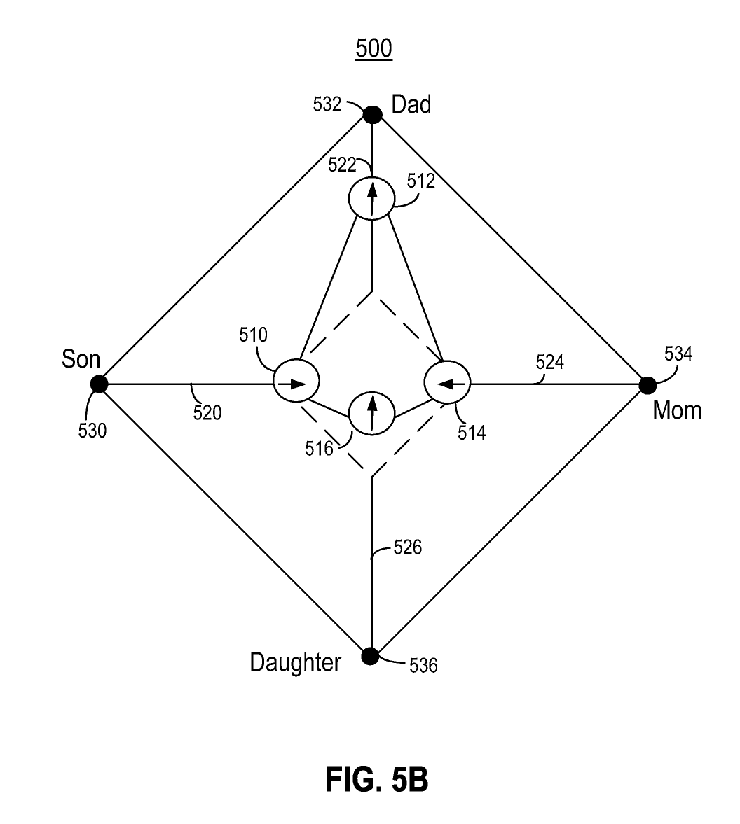

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, graphical user interface option 204 is selected, thus providing graphical user interface display 206 and selection list 250. Selection displays 208, 210, and 212 are also provided. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, display 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The graphical user interface display 206 and displays 208, 210, and 212 are of different sizes (i.e., graphical user interface display 206 is larger than listings 208, 210, and 212), but if desired, all the displays may be the same size. Displays may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

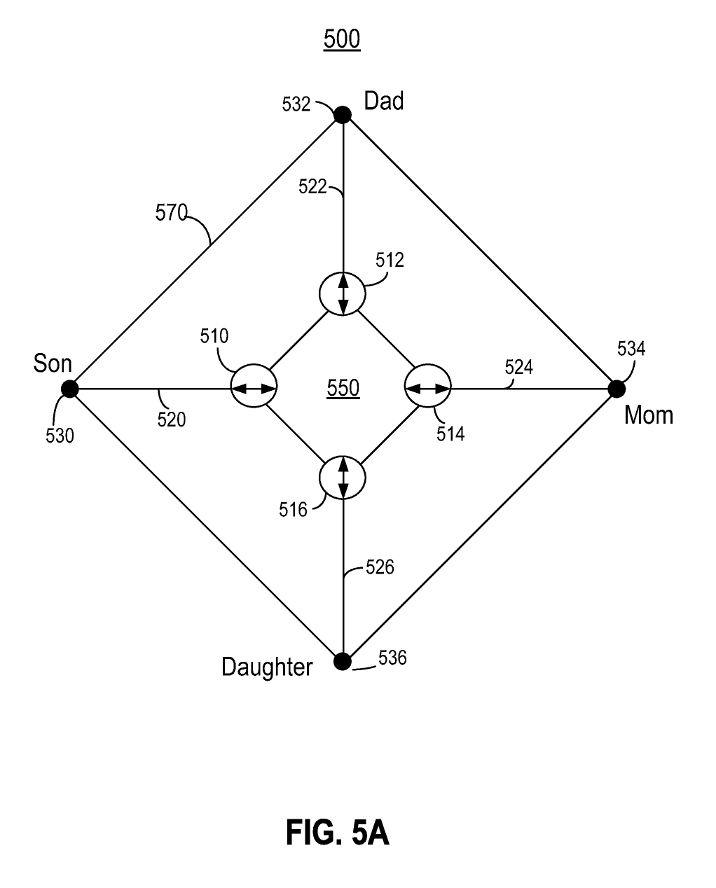

Users may access content and the graphical user interface (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may activate graphical user interface display 206 (FIG. 2), position indicators 510, 512, 514, and 516 (FIG. 5A), or perform any suitable adjustment, selection, or interaction with graphical user interfaces discussed in this disclosure using user input interface 310. User input interface 310 may be any suitable user input device, such as a remote control, mouse, trackball, keypad, keyboard, touch screen, touchpad, stylus input, joystick, voice recognition interface, or other user input devices.

In addition, intelligent detection systems may be used to input information into the graphical user interface without user input. Intelligent detection systems may include, but are not limited to, user proximity detection (e.g., detecting particular users that are within viewing distance of the device displaying the graphical user interface), remote identification of users (e.g., detecting personal identifiers, such as passwords, access codes, electronic signatures, keycards, which are registered to a person), or remote identification of devices, which indicate a user is present (e.g., identifying that a smartphone registered to a particular user is within a proximity suggests that the user is within the same proximity). Furthermore, intelligent detection systems may, based on the time of day, direct the control circuitry 304 to automatically select the profiles associated with particular users to determine a media content selection. In another example, intelligent detection systems may cross-reference the current data and time with devices featuring calendar devices to determine whether or not a particular user, related to a particular profile, is available.

Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and remote server 418 coupled to communications network 414 via communication paths 420 and 422, respectively. Paths 420 and 422 may include any of the communication paths described above in connection with paths 408, 410, and 412. Communications with the content source 416 and remote server 418 may be exchanged over one or more communications paths, but are shown as a single path in FIG. 4 to avoid overcomplicating the drawing. In addition, there may be more than one of each of content source 416 and remote server 418, but only one of each is shown in FIG. 4 to avoid overcomplicating the drawing. (The different types of each of these sources are discussed below.) If desired, content source 416 and remote server 418 may be integrated as one source device. Although communications between media content source 416 and remote server 418 with user equipment devices 402, 404, and 406 are shown as through communications network 414, in some embodiments, source 416 and remote server 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Remote server 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from remote server 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with remote server 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Remote server 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., remote server 418) running on control circuitry of the remote server. When executed by control circuitry of the remote server (such as remote server 418), the media guidance application may instruct the control circuitry to generate the guidance application displays and transmit the generated displays to the user equipment devices. The server application may instruct the control circuitry of the remote server 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more remote servers 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIGS. 5-13 discuss some embodiments of the disclosure. Any step or any result may be obtained by using any of the devices and objects shown or described in FIGS. 1-4. Furthermore, it is contemplated that the steps or descriptions of any embodiment may be used with any other embodiment as appropriate to further the purposes of this disclosure. In addition, the steps and descriptions described herein may be done in alternative orders or in parallel to further the purposes of this disclosure.

FIGS. 5A-C show a graphical user interface in accordance with some embodiments of the disclosure. The graphical user interface 500 is a polygon-shaped graphic. Although, FIGS. 5A-C depict the polygon-shaped graphic to be a certain size and shape, any suitable size and shape may be used.

Furthermore, graphical user interface 500 is not limited to two-dimensional representations. Three-dimensional projections, renderings and images are fully within the teachings of this disclosure. For example, the graphical user interface 500 could appear as three-dimensional object either through the use of three-dimensional technology or could be graphically enhanced to given the appearance of depth. In some embodiments, graphical user interface 500 could also incorporate the use of color, shades, or transparencies to distinguish different regions or boundaries. Graphical user interface 500 may also use multimedia content as appropriate.

Graphical user interface 500 could be displayed on, or provided by, any of the devices shown in FIGS. 3-4. Moreover, graphical user interface 500 could be displayed in the media listing displays shown in FIGS. 1-2. For example, as shown in display 200 (FIG. 2), graphical user interface option 204 (FIG. 2) is displayed among the selectable options 202 (FIG. 2). Upon selecting graphical user interface option 204 (FIG. 2), graphical user interface display 206 (FIG. 2) is displayed. In some embodiments, graphical user interface 500 could be displayed in graphical user interface display 206 (FIG. 2).

Graphical user interface 500 includes four indicators 510, 512, 514 and 516, which form the boundaries of inner boundary 550. Inner boundary 550 obscures a nexus 580 (FIG. 5C) of interface 500. In some embodiments, the nexus 580 (FIG. 5C) may be visible through inner boundary 550. Line segments 520, 522, 524, and 526 originate at the nexus 580 (FIG. 5C) and terminate at respective end points 530, 532, 534, and 536. End points 530, 532, 534 and 536 are connected to form perimeter 570.

In FIG. 5A, line segment 520 is shown to be associated with the profile for “Son.” Line segment 522 is shown to be associated with the profile for “Dad.” Line segment 524 is shown to be associated with the profile for “Mom.” Line segment 536 is shown to be associated with the profile for “Daughter.” Each of these profiles could correspond to a particular person and/or a media content selection criteria associated with that person. For example, the media content selection criteria for “Son” may be associated with a ten year old boy, whose particular interests are cartoons. The profile associated with “Son” may, therefore, include media selection criteria, which gives preference to cartoons. In contrast, the media content selection criteria for “Daughter” may be associated with a fourteen year old girl, whose particular interests are teenage dramas. The profile associated with “Daughter” may, therefore, include media selection criteria, which gives preference to teenage dramas.

In graphical user interface 500, indicators 510, 512, 514, and 516 are shown to be movable about their respective line segments 520, 522, 524, and 526 as indicated by the double-pointed arrows. For example, a user could move indicators 510, 512, 514, and 516 about the length of line segments 520, 522, 524, and 526 to affect the media content selection that is produced by graphical user interface 500 using user input interface 310 (FIG. 3). For example, a user could move indicator 510 closer to end point 530 on the graphical user interface 500.

In graphical user interface 500, the position of indicators 510, 512, 514, and 516 in relation to respective end points 530, 532, 534, and 536 affects the weight that is given to the media content selection criteria found in a particular profile. For example, moving indicator 510 closer to end point 530 may cause the media content selection to be more heavily affected by the media content selection criteria in the profile of “Son.”

End point 530 is connected to adjacent end point 532. End point 532 is connected to adjacent end point 534. End point 534 is connected to adjacent end point 536. End point 536 is connected to adjacent end point 530. The connections between end points 530, 532, 534, and 536 about the nexus 580 (FIG. 5C) form perimeter 570. In some embodiments, perimeter 570 is used to demarcate areas that may be obscured by inner boundary 550 under certain scenarios. For example, if indicator 510 was moved to end point 530 and indicator 516 was moved to end point 536, inner boundary 550 would extend to the portion of the perimeter 570 between end point 530 and end point 536.

In FIG. 5B, a graphical user interface 500 has been affected by the movement of indicators 510, 512, 514, and 516. In FIG. 5B, indicator 512 has been moved closer to end point 532 as indicated by the arrow. Indicator 514 has been moved away from end point 534 as indicated by the arrow. Indicator 516 has been moved away from end point 536 as indicated by the arrow. Indicator 510 has been moved away from endpoint 534 as indicated by the arrow.

In some embodiments, the positions of indicators 510, 514, and 516 may automatically move in response to a user moving, or adjusting the position of, indicator 512. For example, the geometric area associated with the inner boundary 550 (FIG. 5A) may be required to be constant. Therefore, an adjustment to the position of indicator 512 requires an adjustment to the position of the remaining indicators 510, 514, and 516. Furthermore, in some embodiments, the movement of indicator 512 may affect the location of indicator 516 more heavily than the location of indicator 510 or indicator 514. For example, a user adjusting the position of the indicator that is directly across the nexus 580 (FIG. 5C) from another indicator may cause the position of that indicator to move more than indicators that are adjacent to the indicator that is being moved.

In some embodiments, the graphical user interface 500 may display the profile in a particular order about the nexus 580 (FIG. 5C) to improve media content selections. For example, the profiles may be ordered about the nexus 580 (FIG. 5C) according to the media content selection criteria so that media content selection criteria is adjacent to similar media content criteria. For example, in some embodiments, profiles containing similar media content selection criteria may be located closer together around the nexus (as opposed to across the nexus) because a user adjusting the position of the indicator that is directly across the nexus 580 (FIG. 5C) from an opposite indicator may cause the position of the opposite indicator to move more than indicators that are adjacent to the adjusted indicator. In such embodiments, the graphical user interface 500 displays the profiles with opposite (or the most differing) interests across the nexus 580 (FIG. 5C) from each other. This may more accurately interpret the media content selection criteria of interest to the user.

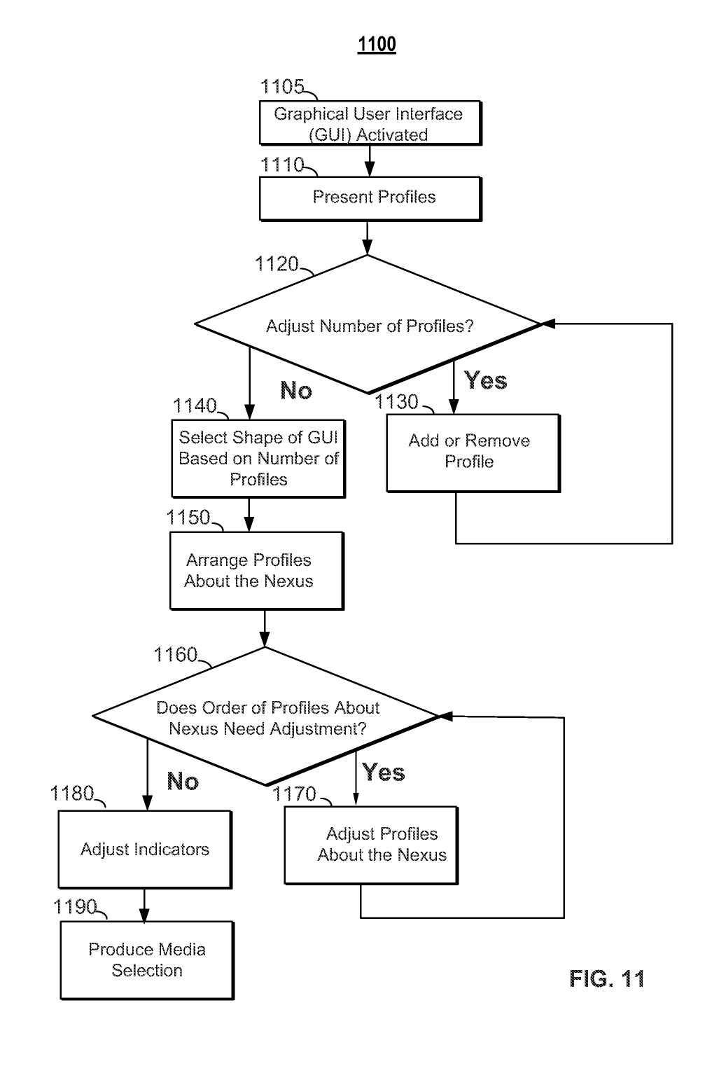

For example, the media content selection criteria of “Dad” may differ the most from the media content selection criteria of “Daughter” (as opposed to the difference between the selection criteria of “Dad” and the selection criteria of “Son” or “Mom”). Therefore, “Dad” and “Daughter” are situated on opposite sides of the nexus 580 (FIG. 5C) in graphical user interface 500. A user may wish to give more preference to the criteria of “Dad” by adjusting the position of indicator 512. In doing so, the remaining indicators may adjust to lessen the preference accorded to the remaining profiles. Moreover, indicator 516 may adjust the most as indicator 516 is positioned across the nexus 580 from indicator 512. Therefore, giving more preference to the media content selection criteria of “Dad” may result in giving less preference to the media content selection criteria that differs the most from that of “Dad,” namely, the media content selection criteria of “Daughter.” The ordering of profiles about the nexus 580 (FIG. 5C) is discussed in further depth in relation to FIG. 11.

FIG. 5C is a graphical user interface in accordance with some embodiments. In FIG. 5C, inner boundary 550 does not obscure nexus 580. Furthermore, FIG. 5C shows numerical indicators 540, 542, 544, and 546. Numerical indicators 540, 542, 544, and 546 provide a numerical indication of the weight given to the media content selection criteria of any one profile. In some embodiments, numerical indicators 540, 542, 544, and 546 may be linked to the location of their respective indicators 510, 512, 514, and 526. For example, indicators 510, 512, 514, and 526 may each be a quarter of the distance from the nexus 580 (FIG. 5C) to their respective end points 530, 532, 534, and 536 on line segments 520, 522, 524, and 526. In some embodiments, this indicates that each of the four profiles will be equally weighted (e.g., each profile's media selection criteria will include twenty-five percent of the composite media selection criteria). Therefore, each numerical indicator 540, 542, 544, and 546 displays a twenty-five percent.

For example, each numerical indicator 540, 542, 544, and 546 may display a percentage of which its respective media content selection criteria are weighted. The positions of indicators 510, 512, 514, and 516 each relate to that percentage. By adjusting the position of indicators 510, 512, 514, and 516, a user may adjust the percentage of weight associated with each media content selection criteria. In some embodiments, the sum of the weights equal one-hundred percent (e.g., the sum of the weights may not be over or under one-hundred percent). Adjusting the position of one of indicators 510, 512, 514, and 516 may be compensated by adjusting the position of the remaining indicators (e.g., increasing the weight of indicator 510 by five percent requires decreasing the sum of the weight of the remaining indicators by a total of five percent) as the sum may not be over one-hundred percent.

Inner boundary 550 (FIG. 5A) rendered in the graphical user interface 500 provides an intuitive display for notifying users that the sum of the percentages associated with the position of indicators 510, 512, 514, and 516 is be equal to one-hundred percent. In some embodiments, inner boundary 550 (FIG. 5A) represents a state where the sum of the percentages associated with the position of indicators 510, 512, 514, and 516 is equal to one-hundred percent. Adjusting the position of indicators 510, 512, 514, and 516 may adjust the configuration of inner boundary 550 (FIG. 5A); however, the area (e.g., the geometric area) of inner boundary 550 (FIG. 5A) maintains the representation of a state where the sum of the percentages associated with the position of indicators 510, 512, 514, and 516 is equal to one-hundred percent, albeit in a different shape. In some embodiments, inner boundary 550 (FIG. 5A) may be reduced to a state where the sum of the percentages associated with the position of indicators 510, 512, 514, and 516 may be equal to or under one-hundred percent. In some embodiments, the color of the inner boundary 550 may change to show over or under utilization of the weights (e.g., the inner boundary 550 (FIG. 5A) is changed to red, if the sum is over one-hundred percent).

FIG. 5C also shows list 560 of media content selections. The media content selections in list 560 are the result of the graphical user interface 500 displaying media content selections in response to the preference given to each profile as indicated by the positions of indicators 510, 512, 514, and 516. For example, according to the current position of indicators 510, 512, 514, and 516 on the graphical user interface 500, the media content selections in list 560 are the three media content selections that are highest rated (e.g., most in-line with the media content selection criteria) media content selections when each profile is weighted equally. In some embodiments, graphical user interface may wait for a command before generating a list 560. In some embodiments, the list 560 may be generated automatically.

List 560 may be an interactive list, allowing a user to select one of the media content selections for playback. Furthermore, the media content selections in list 560 may include additional information such as titles, trailers, actors, authors, producers, descriptions, summaries or any other suitable information about the media content selections.

In some embodiments, the list 560 may include only a single media content selection. Furthermore, in some embodiments, the media content selection may play automatically after it is generated by the graphical user interface 500.

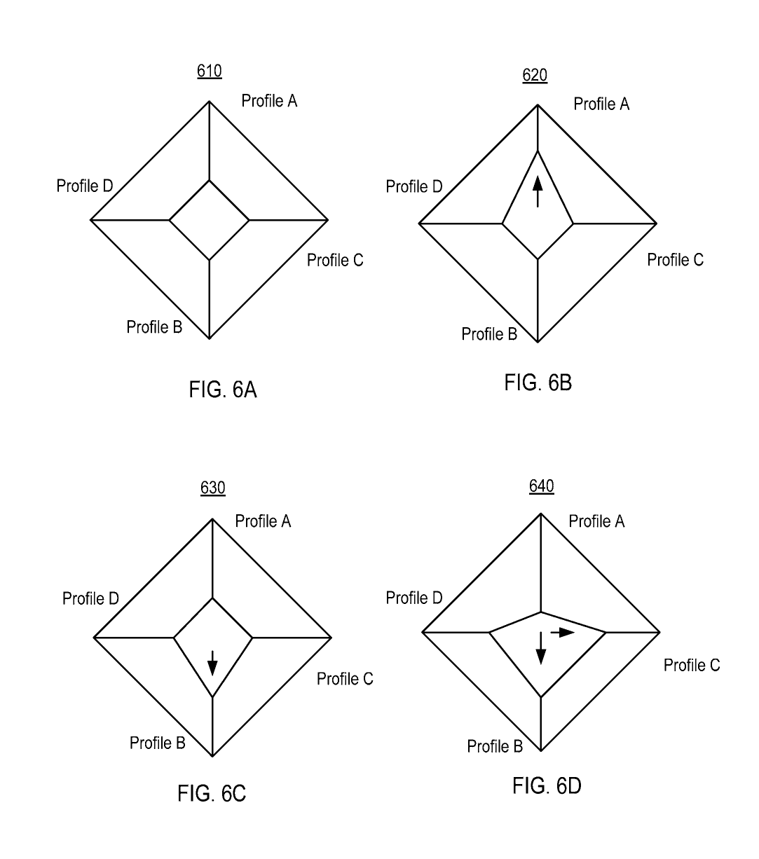

FIGS. 6A-D show a graphical user interface in accordance with some embodiments of the disclosure including four profiles. The graphical user interfaces 610, 620, 630, and 640 are four-sided polygon-shaped graphics. Although, FIGS. 6A-D depict the polygon-shaped graphic to be a certain size and shape, any suitable size and shape may be used for graphical user interfaces 610, 620, 630, and 640. In some embodiments, graphical user interfaces 610, 620, 630, and 640 may also incorporate the use of color, shades, or transparencies to distinguish different regions or boundaries. Graphical user interfaces 610, 620, 630, and 640 may also use multimedia content as appropriate.

Furthermore, graphical user interfaces 610, 620, 630, and 640, are not limited to two-dimensional representations. Three-dimensional projections, renderings and images are fully within the teachings of this disclosure. For example, graphical user interfaces 610, 620, 630, and 640, could appear as three-dimensional objects either through the use of three-dimensional technology or could be graphically enhanced to given the appearance of depth.

Graphical user interfaces 610, 620, 630, and 640, could be displayed on, or provided by, any of the devices shown in FIGS. 3-4. Moreover, graphical user interfaces 610, 620, 630, and 640, could be displayed in the media listing displays shown in FIGS. 1-2. For example, as shown in display 200 (FIG. 2), graphical user interface option 204 (FIG. 2) is displayed among the selectable options 202 (FIG. 2). Upon selecting graphical user interface option 204 (FIG. 2), graphical user interface display 206 (FIG. 2) is displayed. In some embodiments, one or more of graphical user interfaces 610, 620, 630, and 640 could be displayed in graphical user interface display 206 (FIG. 2).

FIG. 6A shows graphical user interface 610 in accordance with some embodiments of the disclosure including four profiles. Graphical user interface 610 is shown in a “default” or beginning position. The position may occur upon the first use by a user. Furthermore, this position may occur after each time a media content selection is made. The position of graphical user interface 610 may also result after a user instructs the system to “reset,” whether or not the command came from a user input or a failure to select the media content selection for playback (e.g., if a certain amount of time passes after the media content selection has been generated, and the media content selection has not be selected, the system may automatically restart).

FIG. 6B shows FIG. 6A after a user has further adjusted particular indicators. Graphical user interface 620 may now generate a media content selection, which more heavily favors “Profile A.” FIG. 6C shows FIG. 6B after further adjustments by the user. Graphical user interface 630 has been adjusted to give preference to “Profile B.” FIG. 6D shows FIG. 6C after further adjustments by the user. Graphical user interface 640 has been adjusted to give preference to “Profile B” and “Profile C,” but with less preference to “Profile A” as discussed in relation to FIG. 5B above.

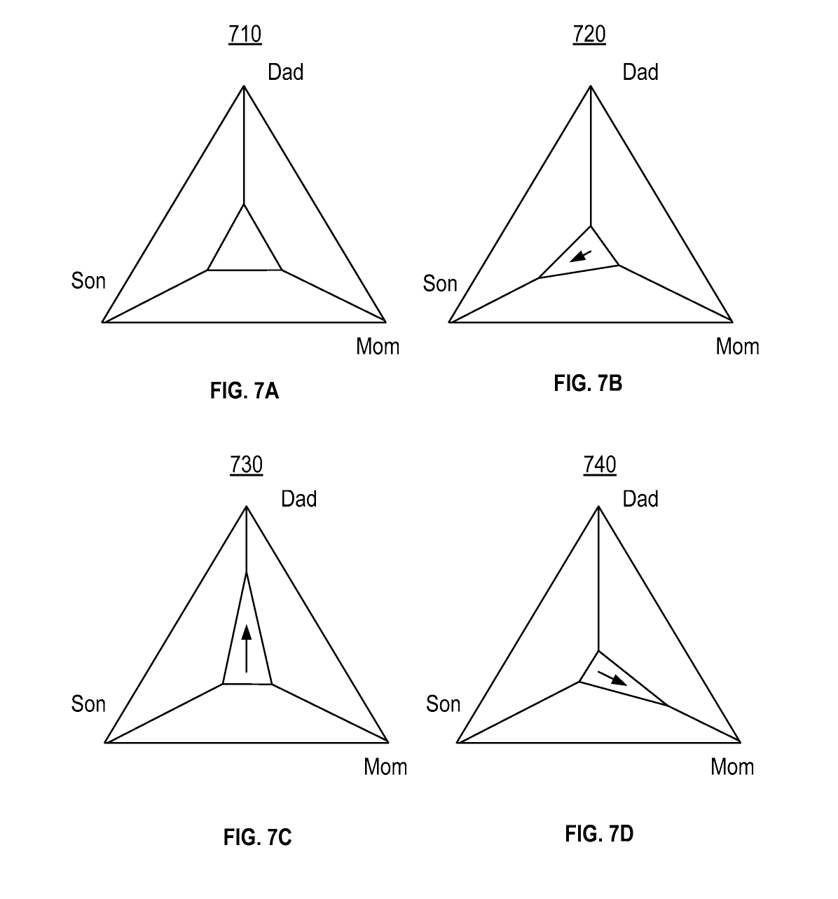

FIGS. 7A-D show a graphical user interface in accordance with some embodiments of the disclosure including four profiles. The graphical user interfaces 710, 720, 730, and 740 are three-sided polygon-shaped graphics. Although, FIGS. 5A-C depict the polygon-shaped graphic to be a certain size and shape, any suitable size and shape may be used for graphical user interfaces 710, 720, 730, and 740.

Furthermore, graphical user interfaces 710, 720, 730, and 740, are not limited to two-dimensional representations. Three-dimensional projections, renderings and images are fully within the teachings of this disclosure. For example, graphical user interfaces 710, 720, 730, and 740, could appear as three-dimensional objects either through the use of three-dimensional technology or could be graphically enhanced to given the appearance of depth.

Graphical user interfaces 710, 720, 730, and 740, could be displayed on, or provided by, any of the devices shown in FIGS. 3-4. Moreover, graphical user interfaces 710, 720, 730, and 740, could be displayed in the media listing displays shown in FIGS. 1-2. For example, as shown in display 200 (FIG. 2), graphical user interface option 204 (FIG. 2) is displayed among the selectable options 202 (FIG. 2). Upon selecting graphical user interface option 204 (FIG. 2), graphical user interface display 206 (FIG. 2) is displayed. In some embodiments, one or more of graphical user interfaces 710, 720, 730, and 740 could be displayed in graphical user interface display 206 (FIG. 2). In some embodiments, graphical user interfaces 710, 720, 730, and 740 may also incorporate the use of color, shades, or transparencies to distinguish different regions or boundaries. Graphical user interfaces 710, 720, 730, and 740 may also use multimedia content as appropriate.

FIG. 7A shows graphical user interface 710 in accordance with some embodiments of the disclosure including three profiles. Graphical user interface 710 is shown in a default position. FIG. 7B shows FIG. 7A after a user has adjusted a particular indicators. Graphical user interface 720 may now generate a media content selection, which more heavily favors “Son.” In this embodiment, graphical user interface 720 resets after any indicator is adjusted. For example, graphical user interface 720 may offer a media content selection after the user has released or stopped moving the indicators. If the media content selection is not watched, the graphical user interface 720 may reset to the graphical user interface 710. FIG. 7C shows graphical user interface 730. Graphical user interface 730 has been adjusted to give preference to “Dad.” FIG. 7D shows graphical user interface 740. Graphical user interface 740 has been adjusted to give preference to “Mom.”

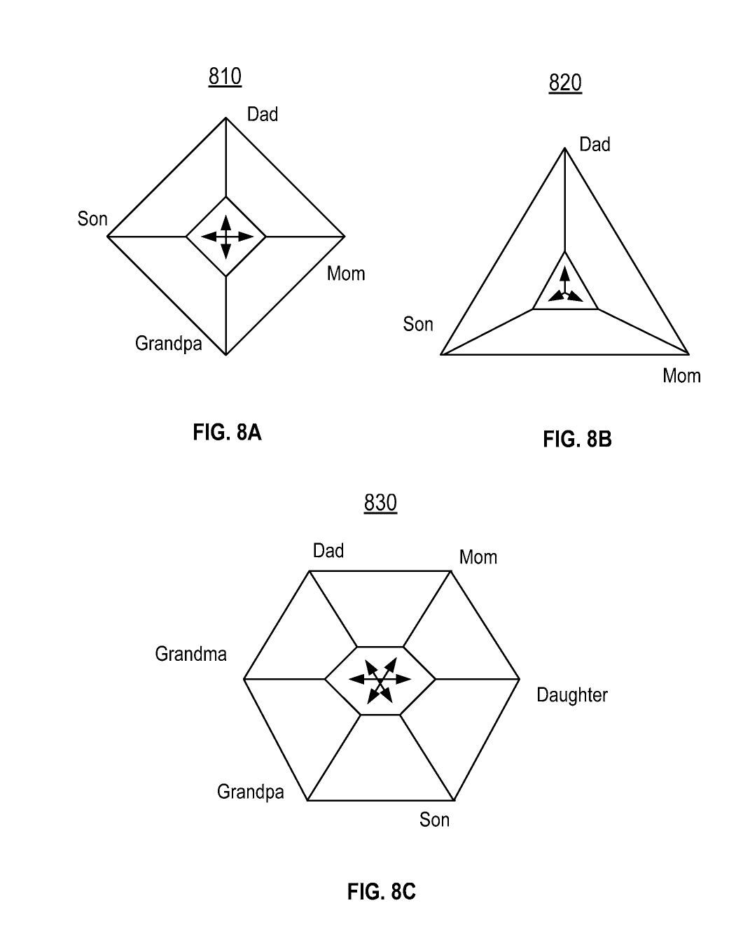

FIG. 8A-C show graphical user interfaces in accordance with some embodiments of the disclosure including a variety of profiles. The graphical user interfaces 810, 820, and 830 shows the result of adding or deleting profiles. Adding or deleting profiles may allow a user to determine which profiles the user would like for the graphical user interface to consider when developing a media content selection. Adding or deleting profiles may occur before the system is initialized or may occur during the use of the system. Although, FIGS. 5A-C depict the polygon-shaped graphic to be a certain size and shape, any suitable size and shape may be used for graphical user interfaces 810, 820, and 830.

Furthermore, graphical user interfaces 810, 820, and 830, are not limited to two-dimensional representations. Three-dimensional projections, renderings and images are fully within the teachings of this disclosure. For example, graphical user interfaces 810, 820, and 830, could appear as three-dimensional objects either through the use of three-dimensional technology or could be graphically enhanced to given the appearance of depth.

Graphical user interfaces 810, 820, and 830, may be displayed on, or provided by, any of the devices shown in FIGS. 3-4. Moreover, graphical user interfaces 810, 820, and 830, could be displayed in the media listing displays shown in FIGS. 1-2. For example, as shown in display 200 (FIG. 2), graphical user interface option 204 (FIG. 2) is displayed among the selectable options 202 (FIG. 2). Upon selecting graphical user interface option 204 (FIG. 2), graphical user interface display 206 (FIG. 2) is displayed. In some embodiments, one or more of graphical user interfaces 710, 720, 730, and 740 could be displayed in graphical user interface display 206 (FIG. 2). In some embodiments, graphical user interfaces 810, 820, and 830 may also incorporate the use of color, shades, or transparencies to distinguish different regions or boundaries. Graphical user interfaces 810, 820, and 830 may also use multimedia content as appropriate.

FIG. 8A shows graphical user interface 810 in accordance with some embodiments of the disclosure including four profiles. Graphical user interface 610 is shown in a “default” or beginning position. FIG. 8B shows graphical user interface 820, which shows the result of removing a profile from graphical user interface 810. In this case, the profile for “Grandpa” has been removed. FIG. 8C shows graphical user interface 830, which shows the result of adding three profiles to graphical user interface 820. In this case, the profile for “Grandpa,” “Grandma,” and “Daughter,” has been added. It should be understood any number of profiles could be added or deleted to the graphical user interfaces of this disclosure. Furthermore, upon the addition or deletion the graphical user interface may adjust itself into a applicable shape, either automatically or after prompting the user.

FIG. 9 is a flow-chart of illustrative steps involved in providing a graphical user interface to select media content in accordance with some embodiments of the disclosure. FIG. 9 shows process 900, which may be performed by, or used on, any of the devices shown in FIGS. 3-4.

At step 910, process 900 retrieves a plurality of profiles from a database (e.g., content source 416 (FIG. 4)). The retrieved profiles include media content selection criteria. Each of the profiles is also associated with a line segment (e.g., line segments 520, 522, 524, and 526 (FIGS. 5A-C)) originating at a nexus (e.g., nexus 580 (FIG. 5C)) and ending at a respective point (e.g., end points 530, 532, 534, and 536 (FIGS. A-C)), and each line segment (e.g., line segments 520, 522, 524, and 526 (FIGS. 5A-C)) also has an indicator (e.g., indicators 512, 514, 516, and 510 (FIGS. 5A-C)) configured to move along the line segment.

At step 920, process 900 will adjust the indicator of each line segment using control circuitry (e.g., the control circuitry 304 (FIG. 3)). At step 930, the media content selection criteria of each profile is then weighted based on a distance between the indicator (e.g., indicators 512, 514, 516, and 510 (FIGS. 5A-C)) of the line segment (e.g., line segments 520, 522, 524, and 526 (FIGS. 5A-C)) associated with the profile and the respective point (e.g., end points 530, 532, 534, and 536 (FIGS. 5A-C)) of the line segment associated with the profile.

At step 940, process 900 generates, using control circuitry (e.g., the control circuitry 304 (FIG. 3)), a media content selection (e.g., list 560 (FIG. 5C)) based at least in part on the weighted media content selection criteria. The media content selection may be displayed on, or provided by, any of the devices shown in FIGS. 3-4, including but not limited to user devices 402, 404, and 406 (FIG. 4). For example, the media content selection may be displayed as selection displays 208, 210, and 212 (FIG. 2) in graphical user interface display 206 (FIG. 2)).

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method.

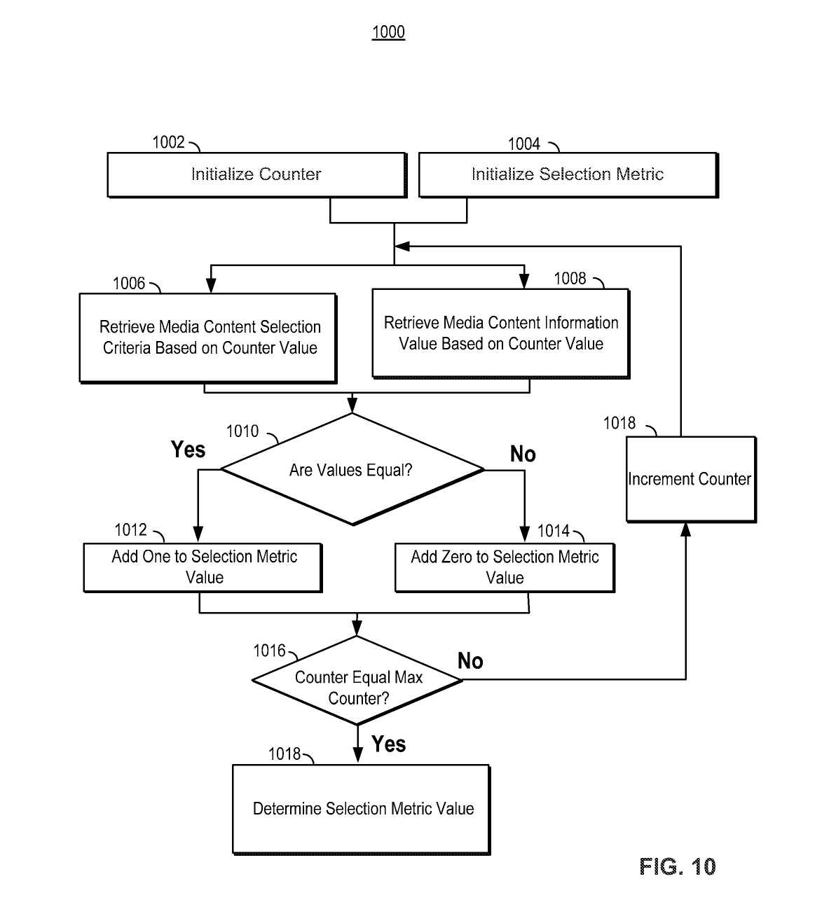

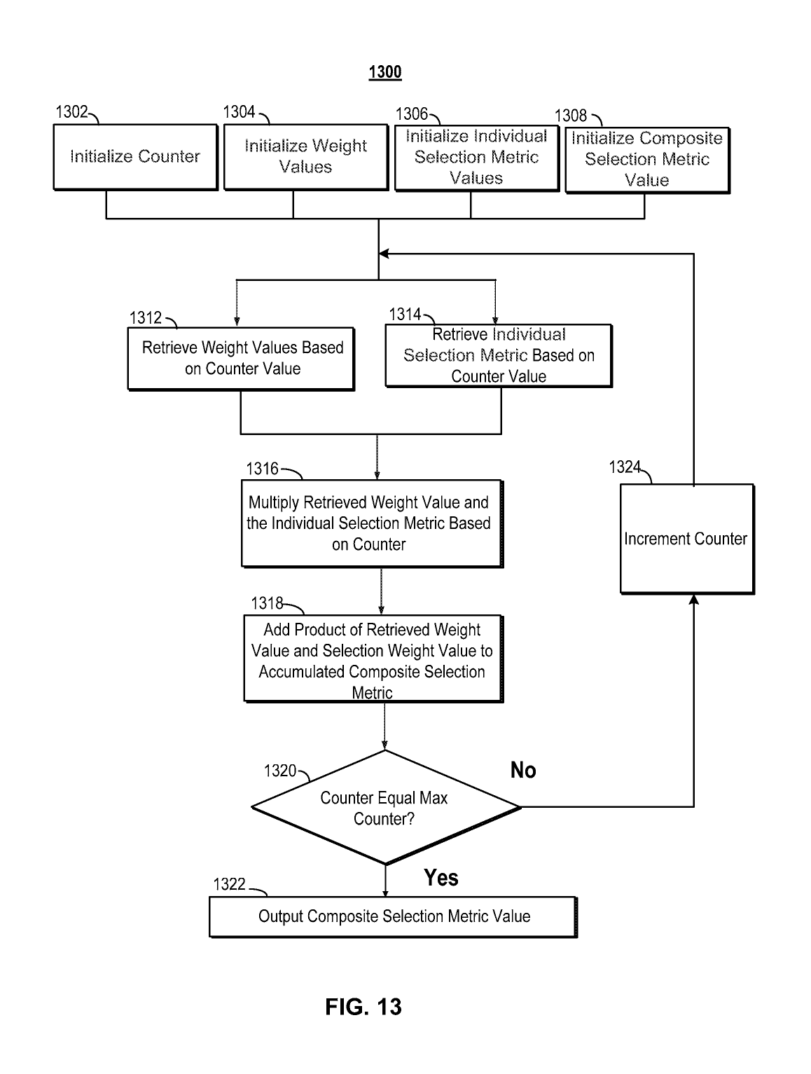

FIG. 10 is a flow-chart of illustrative steps involved in using media content selection criteria to make a media content selection associated with a single profile in some embodiments of the disclosure. Process 1000 determines an individual selection metric for media content available to the user. The individual selection metric may be used to rank media content selections within a single profile. FIG. 13 describes the process of using the individual selection metrics to produce a composite selection metric in some embodiments of this disclosure. Process 1000, and the use of a selection metric, is one embodiment of the disclosure used to provide a media content selection. It should be understood that alternative means for providing a media content selection may be used. Furthermore, process 1000 is but one process used to compute a selection metric between the media content selection criteria and the program information. It should be understood that alternative means for providing a media content selection may be used.

In some embodiments, the profiles may be structured in an array of data fields. The data fields may include textual descriptions of the media content selection criteria or may include values associated with specific attributes or traits of the product. The media content selection criteria may also include a plurality of data fields to describe the user. For example, the data fields may include text or values associated with specific demographics, or the values may relate to the content the particular user enjoys. In some embodiments, information about particular media content may also be structured in an array of data fields. For example, media content may be supplied with metadata containing the media content information.

By comparing corresponding data fields for matching information, the system may determine the media content is of interest to the user. For example, a movie may have a data field associated with a genre that indicates that it is a comedy. The media content selection criteria may also have a data field associated with genres that the user enjoys. If the media content selection criteria data field indicates that comedies are enjoyed by the user, the system can determine that the user will enjoy the movie. Therefore, the system may recommend the movie as a media selection.

At step 1002, process 1000 initializes the counter. At step 1004, process 1000 initializes the selection metric. The counter will be used to track the progression of process 1000 through the array of data fields. The selection metric may be a value used to rank particular media content according to a user's profile. For example, a high selection metric may indicate that the media content meets one or more of the media content selection criteria, and, therefore be of interest to the user associated with the profile. At step 1006, process 1000 retrieves the media content selection criteria based on the counter value. At step 1008, the process 1000 retrieves the media content information value based on the counter value. For example, the counter value may correspond to a particular row of an array. As the counter value increases, process 1000 (e.g., using may process the next data field in an array of data fields.

At step 1010, process 1000 (using content source 416 (FIG. 4), remote server 418 (FIG. 4), user devices 402, 404 and/or 406 (FIG. 4), or any device accessible via the communications network 414 (FIG. 4)) compares the media content selection criteria and the media content information. For example, the server may compare corresponding data fields for the media content selection criteria and the media content information.

The system may use multiple types of object recognition, including fuzzy logic. For example, the particular data field may be a textual data field.

Using fuzzy logic, the system may determine two fields to be identical even though the substance of the data field (e.g., two different spellings) is not identical. In some embodiments, the system may analyze particular data fields of the media content selection criteria and the media content information for particular values or text. The data fields could be associated with categories, genres, series, episodes, products, traits, ratings, targeted audiences, textual descriptions, or any other suitable indicator. Furthermore, the data fields could contain values (e.g., the data fields could be expressed in binary or any other suitable code or programming language).

If the media content selection criteria based on the counter value equals the media content information based on the counter value at step 1010, process 1000 adds a value to the selection metric at step 1012. If the first product value does not equal the second product value, process 1000 does not add a value to the selection metric at step 1014. In some embodiments, the amount of the value may be one. In some embodiments, the amount of the value may depend on the iteration (e.g., the particular counter number). For example, a particular counter number or data field may relate to a particular attribute that should be given more or less weight in the selection metric.

At step 1016, the process 1000 determines if the counter has reached its maximum value. If the counter has not reached the maximum value, process 1000 continues to step 1018, which adds an increment to the counter, and returns to steps 1006 and 1008. If the counter has reached the maximum value, process 1000 determines the value of the selection metric at step 1018.

In some embodiments, the system may establish a threshold amount above which a media content is likely to be of interest to a user, and below which the media content is not likely to be of interest to the user. The particular threshold value may differ depending on the user, profile, and/or media content. Furthermore, the threshold may not depend on the quantity of matches, but the quality of the matches. For example, a particular data field may have more significance as to whether or not a user would prefer the particular media content.

It is contemplated that the steps or descriptions of FIG. 10 may be used with any other embodiment of this disclosure. In addition, the steps and descriptions described in relation to FIG. 10 may be done in alternative orders or in parallel to further the purposes of this disclosure. For example, each of these steps may be performed in any order or in parallel or substantially simultaneously to reduce lag or increase the speed of the system or method.

FIG. 11 is a flow-chart of illustrative steps involved in providing in using a graphical user interface to select media content in accordance with some embodiments of the disclosure and further illustrating steps involved in determining the number of profiles, shape of the graphical user interface, and the order of the profiles in the graphical user interface. It should be noted that process 1100 or any step thereof, could be display on, or provided by, any of the devices shown in FIGS. 3-4.

At step 1105, the graphical user interface 500 (FIG. 5A) is activated. This may occur through a inputting a command (e.g., via user input interface (FIG. 3)) to activate the graphical user interface 500 (FIG. 5A) or may occur through an automated process. For example, the graphical user interface 500 (FIG. 5) may appear upon determining that a user device 402, 404, or 406 (FIG. 4) has been activated. In another example, the graphical user interface 500 (FIG. 5A) may activate automatically upon determining that a user is in need of media guidance (e.g., the system detects channel surfing).

At step 1110 the plurality of profiles is presented. The initial number of profiles may be set a default amount (e.g., the total number of profiles stored on user devices 402, 404, and 406 (FIG. 4)), or the initial amount may be whatever profiles were used in the last media content selection. In some embodiments, the graphical user interface 500 (FIG. 5A) may determine the initial profiles to present according to the time or date. For example, on Saturday mornings, the likely viewers may be children; therefore, the initial profiles for “Son” and “Daughter” (FIG. 5A-C) may be presented. On Friday nights, the likely viewers may be adults; therefore, the initial profiles for “Dad” and “Mom” (FIG. 5A-C) may be presented.

In some embodiments, the graphical user interface (e.g., graphical user interface 500 (FIG. 5A)) may track the users that use the television or computer (e.g., user equipment device 300 (FIG. 3)), which displays the graphical user interface (e.g., graphical user interface 500 (FIG. 5A)) over a period of time (e.g., days, weeks, etc.). If a particular user, who is associated with a particular profile, uses the television or computer (e.g., user equipment device 300 (FIG. 3)) during the period of time (e.g., the past month), the graphical user interface (e.g., graphical user interface 500 (FIG. 5A)) may present the user's profile upon activation. Alternatively, if a particular user, who is associated with a particular profile, does not use the television or computer (e.g., user equipment device 300 (FIG. 3)) during the period of time (e.g., the past month), the graphical user interface (e.g., graphical user interface 500 (FIG. 5A)) may not present the user's profile upon activation.

In some embodiments, the graphical user interface may determine if a particular profile is likely to be used based on a comparison of the usage of the television or computer (e.g., user equipment device 300 (FIG. 3)) of prior dates with similar characteristics to the current date. For example, the profile for “Grandpa” may be used every Thursday night. Therefore, the graphical user interface (e.g., graphical user interface 500 (FIG. 5A)) may present the profile associated with “Grandpa”, if process 1100 determines that the current day of the week is Thursday. In another example, process 1100 may present profiles associated with all family members on days when the family is likely to gather (e.g., calendar holidays) as the family has typically watched the television or computer (e.g., user equipment device 300 (FIG. 3)) on previous days when the family is likely to gather (e.g., previous calendar holidays).

In some embodiments, the graphical user interface (e.g., graphical user interface 500 (FIG. 5A)) may use intelligent detection systems to determine the particular profiles to use. For example, at step 1110, process 1100 may use proximity detection to determine the particular users that are within viewing distance of the television or computer (e.g., user equipment device 300 (FIG. 3)) displaying the graphical user interface (e.g., graphical user interface 500 (FIG. 5A)). The profiles associated with the detected users may then be included in the graphical user interface (e.g., graphical user interface 500 (FIG. 5A)).

In another example, at step 1110, process 1100 may receive remote identification from users (e.g., detecting personal identifiers, such as passwords, access codes, electronic signatures, keycards, which are registered to a person) to determine which users are within viewing distance of the television or computer (e.g., user equipment device 300 (FIG. 3)) displaying the graphical user interface (e.g., graphical user interface 500 (FIG. 5A)). The profiles associated with the detected users may then be included in the graphical user interface (e.g., graphical user interface 500 (FIG. 5A)).

In another example, at step 1110, process 1100 may use remote identification of devices, which indicate a user is present (e.g., identifying that a smartphone registered to a particular user is within a proximity suggests that the user is within the same proximity) to determine which users are within viewing distance of the television or computer (e.g., user equipment device 300 (FIG. 3)) displaying the graphical user interface (e.g., graphical user interface 500 (FIG. 5A)). The profiles associated with the detected users may then be included in the graphical user interface (e.g., graphical user interface 500 (FIG. 5A)).

At step 1120, process 1100 determines whether or not the number of profiles needs to be adjusted. For example, a user may decide that only certain profile may be needed for the particular media content selection. The user may then add or remove a profile at step 1130 using, for example, user input interface 310 (FIG. 3). If the user decides to add or remove a profile process 1100 may return to step 1120. The user may then decide if anymore profiles need to be added or removed. If no more profiles need to be added or remove, process 1100 continues to step 1140.

Based on the number of profiles, process 1100 may determine a shape for graphical user interface 500 (FIG. 5A). For example, if there are three profiles, the shape of graphical user interface 500 (FIG. 5A) may be a triangle. If there are four profiles, the shape of graphical user interface 500 (FIG. 5A) may be a square. If there are five profiles, the shape of graphical user interface 500 (FIG. 5A) may be a pentagon.

After the shape of the graphical user interface 500 (FIG. 5A) has been selected at step 1140, process 1100 arranges the profile about the nexus 580 (FIG. 5C) at step 1150. The order of the profiles, or the line segments 520, 522, 524, and 524 (FIG. 5A) that correspond to the profiles, about the nexus 580 (FIG. 5C) may depend on the particular media content selection criteria within the profile. For example, profiles with similar media content selection criteria may be located closer together, whereas profiles with dissimilar media content selection criteria may be located further away.

For example, in a four-profile embodiment, profiles with the most dissimilar media content selection criteria may be displayed on opposite sides of nexus 580 (FIG. 5C) as discussed in relation to FIG. 5B above. In contrast, profiles with similar media content selection criteria may be located adjacent to each other. In embodiments where the inner boundary 550 (FIG. 5A) is kept constant, by ordering the profiles about the nexus 580 (FIG. 5C) in this way, increasing the weight of one profile may decrease the weight of a profile, which has the most dissimilar media content selection criteria. For example, in reference to FIG. 5B, if the inner boundary 550 (FIG. 5A) is designed to be kept constant, increasing the weight of the profile associated with “Dad,” will decrease the weight of the profile associated with “Daughter.” The profiles associated with “Son” and “Mom” are less affected than the profile associated with “Daughter.” Therefore, when determining an order about the nexus 580 (FIG. 5C), process 1100 may consider the media content selection criteria in each profile, an in this example order the profile for “Dad” and “Daughter” opposite the nexus 580 (FIG. 5C) as they are the most dissimilar profiles.

At step 1160, process 1100 may determine if the order of profiles about the nexus 580 (FIG. 5C) needs to be adjusted. The adjustment may occur automatically via process 1100 or the adjustment may occur through user input. If the order of profiles is determined to need adjustment, process 1100 may adjust the profiles about the nexus 580 (FIG. 5C) at step 1170. If the order of profiles is adjusted at step 1170, process 1100 returns to step 1160. In some embodiments, process 1100 may adjust the order in a single step, alternatively, process 1100 may use several iterations. The process for adjusting the order of profiles about the nexus 580 (FIG. 5C) may include comparing each profile to each other profile to maximize the similarities in media content selection criteria of two adjacent profiles.

If the order of profiles does not need to be adjusted, process 1100 is ready to receive user input as to the positioning of indicators 510, 512, 514, and 516 (FIG. 5A) at step 1180. The indicators 510, 512, 514, and 516 (FIG. 5A) may be adjusted using any suitable method for example using user input interface 310 (FIG. 3).

At step 1190, process 1100 produces a media content selection based on the adjusted indicators 510, 512, 514, and 516 (FIG. 5A). The media content selection may be display on user devices 402, 404, and 406 (FIG. 4).

It is contemplated that the steps or descriptions of FIG. 11 may be used with any other embodiment of this disclosure. In addition, the steps and descriptions described in relation to FIG. 11 may be done in alternative orders or in parallel to further the purposes of this disclosure. For example, each of these steps may be performed in any order or in parallel or substantially simultaneously to reduce lag or increase the speed of the system or method.

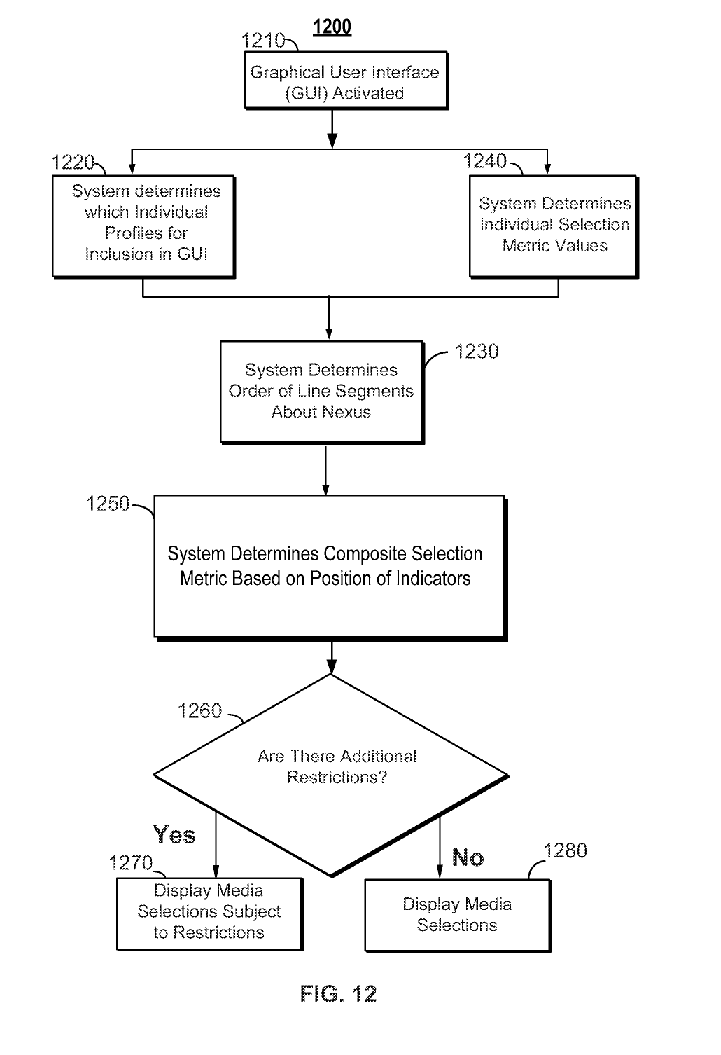

FIG. 12 is a flow-chart of illustrative steps involved in making a media content selection based on media content selection criteria in a plurality of user profiles in some embodiments of the disclosure. It should be noted that system 1200 or any step thereof, could be display on, or provided by, any of the devices shown in FIGS. 3-4.

At step 1210, the graphical user interface 500 (FIG. 5A) is activated. At step 1220, the system determines which profiles to include in the graphical user interface 500 (FIG. 5A), and system 1200 determines the individual selection metric values for media content according to each profile at step 1240. At step 1230, system 1200 determines the order of line segments about the nexus. In some embodiments, system 1200 may use the process or step described in relation to FIG. 11.

At step 1250, system 1200 determines the composite selection metric value for each media content. The composite selection metric value incorporates the weight given to each profile's individual selection value, as determined by the position of indicators 510, 512, 514, and 516 (FIG. 5A), to arrive at a composite selection metric value. In some embodiments, the composite selection metric may be calculated in accordance with a weighted function. In some embodiments, the composite function may take the form of:

$$Composite = {\sum }_{i = 1}^{N} {w}_{i} {t}_{i} \qquad ( EQ . 1 )$$

where N is the total number of profiles, w is the weight assigned to the particular profile, and t is the individual selection metric for a particular media content.

For example, a particular graphical user interface 500 (FIG. 5A), has three profiles. Using, for example, process 1000 (FIG. 10), the graphical user interface 500 (FIG. 5A) may calculate an individual selection metric value for each of the three profiles. Based on the positions of the profiles' respective indicators, a weight is assigned to each selection metric value. By processing each selection metric value, according to its respective weight, through EQ. 1, a composite selection metric value may be obtained. The composite selection metric value for the media content may then be compared to the composite selection metric value for all other media content. In some embodiments, the media content with the highest composite selection metric value may be produced by the graphical user interface 500 (FIG. 5A) as the media content selection. In some embodiments, a list (e.g., list 560 (FIG. 5C)) may be displayed showing the media content selections with the highest composite selection metric values.

At step 1260, system 1200 determines if there are any additional restrictions. In some embodiments, additional restrictions are factors in addition to media content selection criteria that are used to determine a media content selection. The additional restrictions may affect the media content selection, but not any of the media content selection criteria associated with an individual profile or the individual selection metric value. For example, a user may enter a requirement that no movie with an “R” rating may be shown. If the movie with the highest composite selection metric has an “R” rating the movie may not be produced, and the movie with the next highest composite selection metric will be displayed at step 1270.

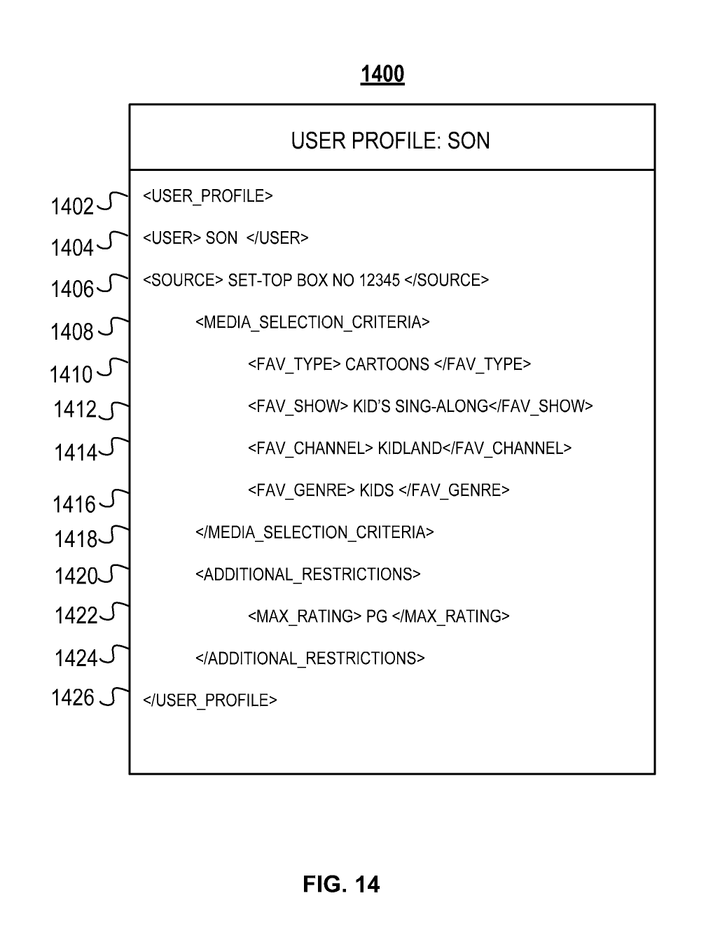

The additional restrictions may be applied to the graphical user interface (e.g., graphical user interface 500 (FIGS. A-C)) by a user, while the user is adjusting the indicators (e.g., indicators 510, 512, 514, and 516 (FIGS. A-C)). For example, the additional restrictions may be among the selectable options 202 (FIG. 2) as shown in display 200 (FIG. 2) along with graphical user interface option 204 (FIG. 2). In some embodiments, upon selecting graphical user interface option 204 (FIG. 2), graphical user interface display 206 (FIG. 2) is displayed and may prompt the user to select additional restrictions, if any, that may be applied. In some embodiments, the additional restrictions may be applied automatically anytime a particular profile (e.g., a profile for a child) is used in the graphical user interface (e.g., graphical user interface 500 (FIG. 5A-C)). In some embodiments, the additional restrictions may be contained in the user profile (e.g., line 1422 of FIG. 14)).

If there are no additional restrictions, the media content selection with the highest composite selection metric is displayed at step 1280. It should be noted that in some embodiments, multiple media content selections (e.g., in list 560 (FIG. 5C)) may be produced. For example, instead of showing only the movie with the highest composite selection metric, the graphical user interface 500 (FIG. 5A) could show the movies with the five highest composite selection metrics.

It is contemplated that the steps or descriptions of FIG. 12 may be used with any other embodiment of this disclosure. In addition, the steps and descriptions described in relation to FIG. 12 may be done in alternative orders or in parallel to further the purposes of this disclosure. For example, each of these steps may be performed in any order or in parallel or substantially simultaneously to reduce lag or increase the speed of the system or method.

FIG. 13 is a flowchart of an illustrative process used to determine a composite selection metric value associated with particular media content. For example, in some embodiments, the steps shown and described in FIG. 13 may represent the processes occurring at step 1250 (FIG. 12).

The illustrative embodiments of process 1300 depict steps performed in accordance with EQ. 1. It should be noted that system 1200 or any step thereof, could be display on, or provided by, any of the devices shown in FIGS. 3-4.

Process 1300 begins by initializing several variables. Specifically, process 1300 initializes a counter at step 1302, weight values at step 1304, individual selection metric values (which in some embodiments may have been derived via process 1000 (FIG. 10) at step 1306, and composite metric value at step 1308. Each of the values may correspond to values discussed in relation to FIG. 12, and process 1300 may process all available media content in an array of one through N entries. For example, process 1300 may describe each iteration (each iteration determining the composite selection metric for each media content) beginning with the first iteration and ending with the Nth iteration (N being the total number of media content available to the user).

After the counter, weight values, individual selection metric values, and composite selection metric value are initialized in steps 1302, 1304, 1306, and 1308, respectively, process 1300 retrieves a weight based on the counter at step 1312 and an individual selection metric value based on the counter at step 1314.

At step 1316, process 1300 multiplies the individual selection metric value and weight value retrieved in steps 1312 and 1314, respectively. At step 1318, process 1300 adds the product of step 1316 to the accumulated lifetime. At step 1320, the system determines if the counter equals the maximum counter value (e.g., whether there are additional iterations that need to be performed). If there are additional iterations, the system may return to steps 1312 and 1314 and repeat the process after increasing the counter by an increment at step 1324. If there are no more iterations (e.g., the counter has reached the maximum N value), the system may output the lifetime of the product at step 1322.

It is contemplated that the steps or descriptions of FIG. 13 may be used with any other embodiment of this disclosure. In addition, the steps and descriptions described in relation to FIG. 13 may be done in alternative orders or in parallel to further the purposes of this disclosure. For example, each of these steps may be performed in any order or in parallel or substantially simultaneously to reduce lag or increase the speed of the system or method.

Furthermore, FIG. 13 (and EQ. 1) is but one possible process for determining the composite selection metric value of particular media content. Although FIG. 13 discusses the use of EQ. 1, any suitable process, algorithm, and/or method may also be used.

FIG. 14 shows an exemplary data structure for a user profile in accordance with some embodiments of the disclosure. Data structure 1400 may be used by a graphical user interface (e.g., graphical user interface 500 (FIG. 5A-C)) in displaying a media content selection (e.g., as discussed in relation to step 940 (FIG. 9). Data structure 1400 may be stored on any of the devices shown in FIGS. 3-4. For example, data structure 1400 may represent a profile as stored by storage 308 (FIG. 3).

At line 1402, data structure 1400 indicates that data structure 1400 is for a user profile. At line 1404, data structure 1400 indicates that the user profile is for “Son.” For example, data structure 1400 may relate to the profile and media content selection criteria of “Son” as discussed in regards to FIG. 5B. At line 1406, data structure 1400 indicates that the source of the profile is a set-top box (e.g., storage 308 (FIG. 3)).

At line 1408, data structure 1400 indicates the presence of media content selection criteria (e.g., the media content selection criteria as discussed in relation to FIG. 9)). Line 1410 of data structure 1400 indicates that the user's favorite type of program is “Cartoons.” Line 1412 of data structure 1400 indicates that the user's favorite show is “Kid's Sing-Along.” Line 1414 of data structure 1400 indicates the user's favorite channel is “KidLand.” Line 1416 of data structure 1400 indicates that the user's favorite genre is “Kids.” Line 1418 of data structure 1400 indicates the end of the media content selection criteria.

At line 1420, data structure 1400 indicates the presence of additional restrictions (e.g., the additional restrictions as discussed in relation to FIG. 12)). Line 1422 of data structure 1400 indicates that an additional restriction of the user's profile is that the maximum rating that a media content selection may have is a “PG” rating, and line 928 indicates the end of the transmission. Line 1424 of data structure 1400 indicates the end of the additional restrictions, and line 1426 of data structure 1400 indicates the end of the user profile.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel.

What is claimed is:

1. A method for providing a media content selection on a graphical user interface, comprising:
retrieving a plurality of profiles from a database, said profiles comprising media content selection criteria, wherein each profile is associated with a line segment originating at a nexus and ending at a respective point in a graphical user interface (GUI), and each line segment having an indicator configured to move along the line segment in the GUI;
adjusting, using control circuitry, the indicator of at least one line segment;
weighting the media content selection criteria of each profile based on a distance between the indicator of the line segment associated with the profile and the respective point of the line segment associated with the profile; and
generating, using control circuitry, a media content selection based at least in part on the weighted media content selection criteria of the plurality of profiles.

2. The method of claim 1, further comprising:
in response to adjusting the indicator on one line segment, adjusting the indicators of the remaining line segments in the GUI.

3. The method of claim 1, further comprising displaying a numerical value indicating the weight given to the media content selection criteria of each profile.

4. The method of claim 3, wherein the indicator of each line segment is connected to the indicator of an adjacent line segment about the nexus to form an inner boundary, wherein the method further comprises:
calculating a sum value associated with the inner boundary by calculating the sum of the numerical value of the weight given to each profile; and
maintaining the sum value of the inner boundary while adjusting the position of the indicator on one line segment by adjusting the position of the indicators on the remaining line segments.

5. The method of claim 1, further comprising ordering the line segments about the nexus in the GUI based on the profile associated with each line segment.

6. The method of claim 1, further comprising rendering each line segment in the GUI with an equal length and rendering each point of each line segment is equal distance to an adjacent point about the nexus.

7. The method of claim 1, further comprising rendering the media content selection in the GUI within a list of a plurality of media content selections.

8. The method of claim 7, further comprising ranking the plurality of media content selections in the list according to a composite selection metric calculated for each media content selection.

9. The method of claim 1, further comprising generating the media content selection based at least in part on additional restrictions not associated with the media content selection criteria of any profile.

10. The method of claim 1, further comprising adding or removing one profile comprising media content selection criteria used to determine the media content selection causing the addition or removal of the line segment associated with the one profile from the GUI.

11. A system for selecting media content, comprising a processor configured to:
render a graphical user interface (GUI), said graphical user interface, comprising:
a nexus; and
a plurality of line segments, each line segment originating at the nexus and ending at a respective point, and each line segment having an indicator configured to move along the line segment;
maintain a plurality of profiles comprising media content selection criteria, wherein each profile is associated with one line segment of the plurality of line segments;
weight the media content selection criteria of each profile based on a distance between the indicator of the line segment associated with the profile and the respective point of the line segment associated with the profile; and
display a media content selection, wherein the media content selection is based at least in part on the weighted media content selection criteria of the plurality of profiles.

12. The system of claim 11, wherein the processor is further configured to, in response to an adjustment of the position of the indicator on one line segment, adjust the indicators of the remaining line segments rendered in the GUI.

13. The system of claim 11, wherein the processor is further configured to display a numerical value of the weight given to the media content selection criteria of each profile.

14. The system of claim 13, further comprising an inner boundary rendered in the GUI formed through the connection of the indicator of each line segment to the indicator of an adjacent line segment about the nexus, wherein the processor is further configured to:
calculate a sum value associated with the inner boundary by calculating the sum of the numerical value of the weight given to each profile; and
maintain the sum value of the inner boundary while adjusting the position of the indicator on one line segment by adjusting the position of the indicators on the remaining line segments.

15. The system of claim 11, wherein the processor is further configured to render each line segment associated with the plurality of profiles in the GUI an equal length and each respective point of each line segment an equal distance to an adjacent respective point about the nexus.

16. The system of claim 11, wherein the processor is further configured to order the line segments about the nexus in the GUI based on the media content selection criteria of the profile associated with each line segment.

17. The system of claim 11, wherein the processor is further configured to display the media content selection within a list of a plurality of media content selections.

18. The system of claim 17, wherein the processor is further configured to rank, according to a composite selection metric calculated for each media content selection, the plurality of media content selections in the list.

19. The system of claim 11, wherein the processor is further configured to display the media content selection based at least in part on additional restrictions not associated with the media content selection criteria of any profile.

20. The system of claim 11, wherein the processor is further configured to add or remove one profile comprising media content selection criteria used to determine the media content selection causing the addition or removal of the line segment associated with the one profile rendered on the GUI.

21. A system for providing a media content selection on a graphical user interface, comprising:
means for retrieving a plurality of profiles from a database, said profiles comprising media content selection criteria, wherein each profile is associated with a line segment originating at a nexus and ending at a respective point in a graphical user interface (GUI), and each line segment having an indicator configured to move along the line segment in the GUI;
means for adjusting, using control circuitry, the indicator of at least one line segment;
means for weighting the media content selection criteria of each profile based on a distance between the indicator of the line segment associated with the profile and the respective point of the line segment associated with the profile; and
means for generating, using control circuitry, a media content selection based at least in part on the weighted media content selection criteria of the plurality of profiles.

22. The system of claim 21, further comprising:
in response to adjusting the indicator on one line segment, means for adjusting the indicators of the remaining line segments in the GUI.

23. The system of claim 21, further comprising means for displaying a numerical value indicating the weight given to the media content selection criteria of each profile.

24. The system of claim 23, wherein the indicator of each line segment is connected to the indicator of an adjacent line segment about the nexus to form an inner boundary, wherein the system further comprises:
means for calculating a sum value associated with the inner boundary by calculating the sum of the numerical value of the weight given to each profile; and
means for maintaining the sum value of the inner boundary while adjusting the position of the indicator on one line segment by adjusting the position of the indicators on the remaining line segments.

25. The system of claim 21, means for ordering the line segments about the nexus in the GUI based on the profile associated with each line segment.

26. The system of claim 21, further comprising means for rendering each line segment in the GUI with an equal length and rendering each respective point of each line segment equal distance to an adjacent respective point about the nexus.

27. The system of claim 21, further comprising means for rendering the media content selection in the GUI within a list of a plurality of media content selections.

28. The system of claim 27, further comprising means for ranking the plurality of media content selections in the list according to a composite selection metric calculated for each media content selection.

29. The system of claim 21, further comprising means for generating the media content selection based at least in part on additional restrictions not associated with the media content selection criteria of any profile.

30. The system of claim 21, further comprising means for adding or removing one profile comprising media content selection criteria used to determine the media content selection causing the addition or removal of the line segment associated with the one profile from the GUI.
